(19) United States
(12) Patent Application Publication
(10) Pub. No.: US 2013/0229337 A1
(43) Pub. Date: Sep. 5, 2013

(54) ELECTRONIC DEVICE, ELECTRONIC DEVICE CONTROLLING METHOD, COMPUTER PROGRAM PRODUCT

(71) Applicant: KABUSHIKI KAISHA TOSHIBA, Tokyo (JP)

(72) Inventors: Hideaki Andou, Ome-shi (JP); Tsukasa Nunami, Ome-shi (JP); Yuuji Irimoto, Fussa-shi (JP); Ryuhei Yokota, Tachikawa-shi (JP)

(73) Assignee: KABUSHIKI KAISHA TOSHIBA, Tokyo (JP)

(21) Appl. No.: 13/766,384

(22) Filed: Feb. 13, 2013

(30) Foreign Application Priority Data
Mar. 2, 2012 (JP) 2012-047335

(51) Int. Cl. G06F 3/00

(52) U.S. Cl. CPC G06F 3/005
USPC 345/156

(57) ABSTRACT

According to one embodiment, an electronic device includes: a display controller; a user presence determination module; a reference elapsed time storage module; an interval time setting module; and a display controller. The display controller causes a display to display various types of information. The user presence determination module determines whether a user is present at a first time interval. The reference elapsed time storage module stores therein a second time for changing an operation mode to a power saving mode based on a time elapsed from when a user operation is ceased to be detected. The interval time setting module sets the first time interval shorter than the second time based on the second time stored in the reference elapsed time storage module. The display controller turns off the display if the user presence determination module determines that the user is absent.

### CROSS-REFERENCE TO RELATED APPLICATIONS

This application is based upon and claims the benefit of priority from Japanese Patent Application No. 2012-047335, filed on Mar. 2, 2012, the entire contents of which are incorporated herein by reference.

### FIELD

Embodiments described herein relate generally to an electronic device, an electronic device controlling method, and a computer program product.

### BACKGROUND

Conventionally, there is known a power saving technology for display devices such as televisions and displays, by detecting a condition that the user has not been using the display and by shutting down a display.

For example, the power saving is achieved by turning off the television in accordance with a detection state of a user's face captured by a capturing module, thereby preventing the television from displaying images while there are no viewers around.

Further, there is disclosed a technology of detecting a user who is not seated on a predetermined seat by capturing its image with a camera, thereby stopping to display images on the display screen.

To quickly make a transition to a power saving mode and to quickly recover a normal operation mode from the power saving mode, it is required to keep operating the mean for capturing the user, all the time. Therefore, there is a possibility that the power consumption might not be able to be reduced.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of an information processor, which is an electronic device, according to a first embodiment;

FIG. 2 is an exemplary flowchart of operations of the information processor in the first embodiment;

FIG. 3A is an exemplary schematic diagram for explaining power plan settings in the first embodiment;

FIG. 3B is an exemplary schematic diagram for explaining other power plan settings in the first embodiment;

FIG. 4 is an exemplary schematic diagram for explaining a method of calculating a face detection interval in the first embodiment;

FIG. 5 is an exemplary block diagram of a configuration of an information processor in a modification of the first embodiment; and

FIG. 6 is an exemplary block diagram of a general configuration of an information processor according to a second embodiment.

### DETAILED DESCRIPTION

In general, according to one embodiment, an electronic device comprises: a display controller; a user presence determination module; a reference elapsed time storage module; an interval time setting module; and a display controller. The display controller is configured to cause a display to display various types of information. The user presence determination module is configured to determine whether a user is present at a first time interval. The reference elapsed time storage module is configured to store therein a second time for changing an operation mode to a power saving mode based on a time elapsed from when a user operation is ceased to be detected. The interval time setting module is configured to set the first time interval shorter than the second time based on the second time stored in the reference elapsed time storage module. The display controller is configured to turn off the display if the user presence determination module determines that the user is absent.

Embodiments will now be explained in detail with reference to accompanying drawings.

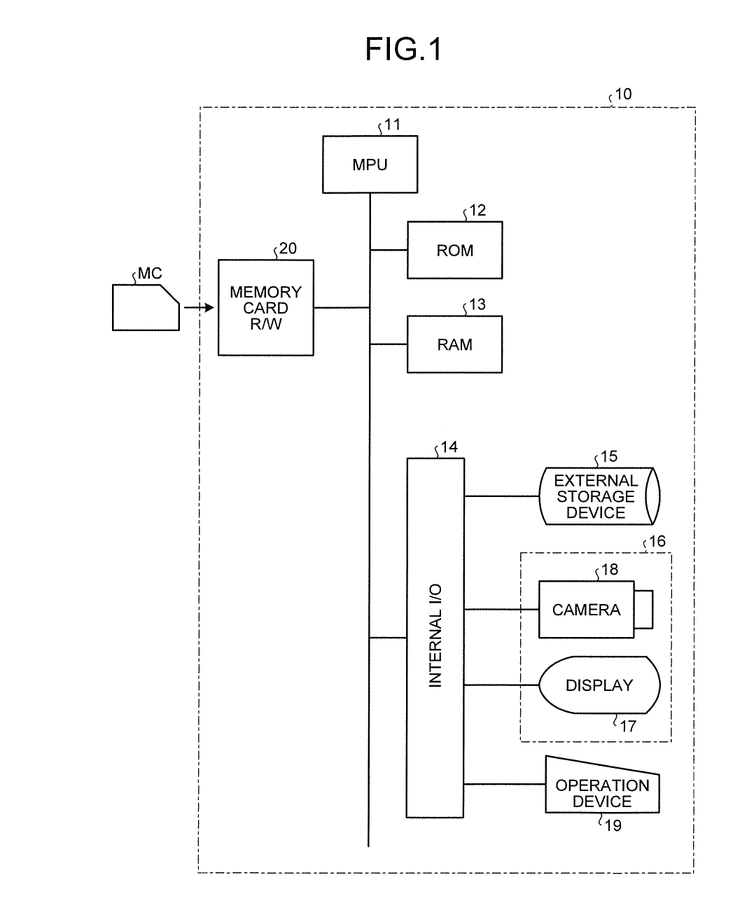

FIG. 1 is a block diagram of an outlined configuration of an information processor, which is an electronic device according to a first embodiment.

An information processor 10 according to the first embodiment is configured as a laptop personal computer (PC) having a camera.

The information processor 10 comprises a micro-processing unit (MPU) 11 that controls the overall information processor 10, a read-only memory (ROM) 12 being a non-volatile memory storing therein control programs and the like executed by the MPU 11, a random access memory (RAM) 13 that is used as a working area of the MPU 11 and temporarily stores therein various types of data, an internal input/output (I/O) (I/O module) 14 performing various interfacing operations, and an external storage device 15 configured as a hard disk drive, a solid state disk (SSD), or the like connected via the internal I/O 14 and storing therein various types of data.

The information processor 10 comprises a display 17 configured as a liquid crystal display, an electroluminescent (EL) display, or the like housed in a display panel module 16, a camera 18 being a camera device including charge coupled device (CCD) imaging elements or complementary metal oxide semiconductor (CMOS) imaging elements, an operation device 19 configured as a keyboard, a touch panel, a mouse, and the like and allowing a user to perform various operations, and a memory card reader-writer (R/W) 20 into which a memory card MC that is a recording medium is inserted and that reads and writes various types of data.

An operation according to the first embodiment will now be explained.

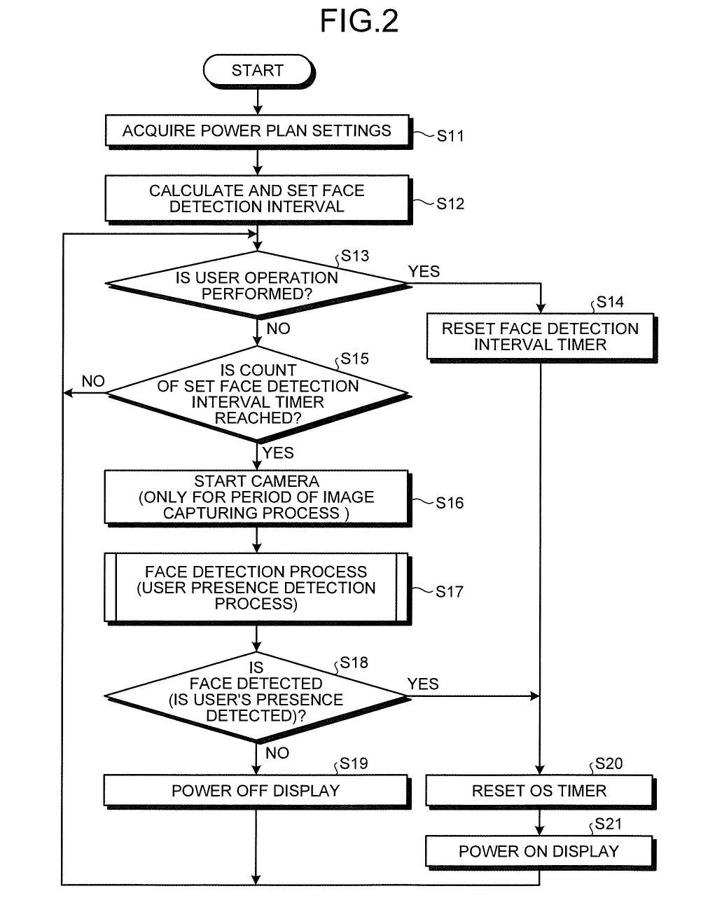

FIG. 2 is a flowchart of outlined operations in the first embodiment.

It is assumed herein that, as an initial condition, the camera 18 is powered off, and the display is powered on.

To begin with, the MPU refers to power plan setting data of an operating system (OS), and acquires power plan settings (S11).

The power plan setting is specified as a continuous time period (corresponding to a second time: reference elapsed time) during which a user perform no operation, from when a state in which the user perform no operation is detected in the information processor 10 to when a transition is made to a predetermined power saving mode.

The following four types of the power saving modes are available in the embodiment.
(1) Display brightness reduction mode
(2) Display power-off mode
(3) Information processor (computer) sleep mode
(4) Information processor (computer) hibernation mode

The display brightness reduction mode saves power by reducing the amount of light output from backlights when the display is a backlight liquid crystal display.

The display power-off mode powers off the display, so that only a standby power is consumed. It goes without saying that, if the display is a backlight liquid crystal display, all of the backlights are turned off.

The information processor sleep mode is a state corresponding to the sleep state S3 according to the Advanced Configuration and Power Interface (ACPI) Specification, which is one of the standards related to power savings of PCs. This is a power saving mode that suppresses power consumption by powering off devices such as a display function, an external storage device, and the like. In the sleep mode, because power is kept supplied to the RAM so that data currently being processed is maintained as it is, the information processor 10 can be resumed from where the work is stopped, unlike when the information processor is powered off and then powered on. In addition, a normal operation mode can be quickly recovered, e.g., within a few seconds, from the information processor sleep mode.

The information processor hibernation mode is a state corresponding to the sleep state S4 according to the ACPI Specification. This is a mode that saves the content of the RAM 13 in the external storage device 15, such as a hard disk drive, and then powering off the devices including the RAM 13. Therefore, an area for saving the data before making a transition to the hibernation is reserved in the storage area of the external storage device 15, in the memory capacity almost equal to the RAM 13. In the information processor hibernation mode, the information processor 10 is put in a state substantially the same as that of when the information processor 10 is powered off, unlike in the information processor sleep mode.

However, because the information processor 10 is required to save or to read the content of the RAM 13 in or from the external storage device 15, it takes time to make a transition to or recover from the information processor hibernation mode.

From the viewpoint of the device, the information processor 10 in both the information processor sleep mode and the information processor hibernation mode is in a state almost the same as that of when the information processor 10 is powered off. Therefore, in order to make transition to each mode, devices and device drivers needs to be completed and initialized as similar to the shutdown and system boot up (power on) for recovery.

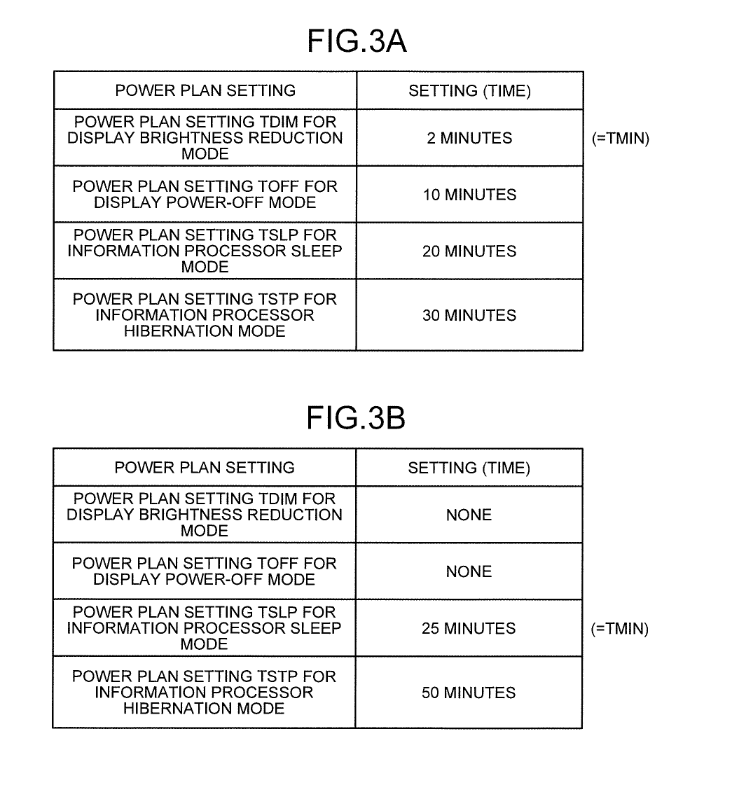

FIGS. 3A and 3B are schematic diagrams for explaining an example of the power plan settings.

There are four types of power plan settings according to the embodiment, as illustrated in FIGS. 3A and 3B, in a manner corresponding to the power saving modes explained above. These types include a power plan setting TDIM corresponding to the display brightness reduction mode, a power plan setting TOFF corresponding to the display power-off mode, a power plan setting TSLP corresponding to the information processor (computer) sleep mode, and a power plan setting TSTP corresponding to the information processor (computer) hibernation mode.

The power plan setting is set to an OS timer managed by the MPU 11 mainly under control of the OS. When the time specified in the power plan setting has elapsed from the time when a user stops making operations, the operation mode is changed to a corresponding power saving mode. In the explanation below, the power plan settings are set in unit of minutes.

In the specific example of the power plan settings illustrated in FIG. 3A, the power plan setting TDIM corresponding to the display brightness reduction mode is set to 2 minutes, the power plan setting TOFF corresponding to the display power-off mode is set to 10 minutes, the power plan setting TSLP corresponding to the information processor sleep mode is set to 20 minutes, and the power plan setting TSTP corresponding to the information processor hibernation mode is set to 30 minutes.

In another example illustrated in FIG. 3B, the power plan setting TDIM corresponding to the display brightness reduction mode is set to none, the power plan setting TOFF corresponding to the display power-off mode is set to none, the power plan setting TSLP corresponding to the information processor (computer) sleep mode is set to 25 minutes, the power plan setting TSTP corresponding to the information processor (computer) hibernation mode is set to 50 minutes.

Based on the power plan setting TDIM, the power plan setting TOFF, the power plan setting TSLP, and the power plan setting TSTP acquired at S11, the MPU 11 identifies a power plan setting TMIN that is the power plan setting specified with the shortest time among these power plan settings, and calculates and sets face detection interval time (corresponding to a first time interval) (S12).

More specifically, in the example illustrated in FIG. 3A, because the power plan setting TDIM corresponding to the display brightness reduction mode is specified with the shortest time, the MPU 11 sets TMIN to TDIM.

Similarly, in the example illustrated in FIG. 3B, because the power plan setting TSLP corresponding to the information processor sleep mode is specified with the shortest time, the MPU 11 sets TMIN to TSLP.

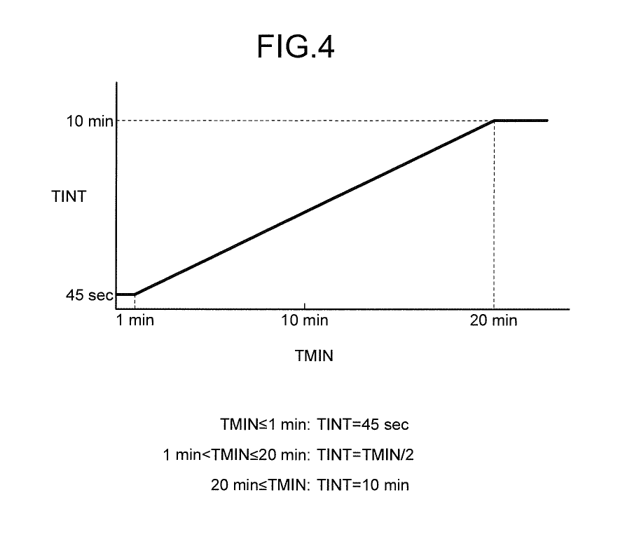

FIG. 4 is a general schematic diagram for explaining a method of calculating the face detection interval.

The MPU 11 then determines to which one of equal to or less than 1 minute, more than 1 minute and less than 20 minutes, or equal to or more than 20 minutes the power plan setting specified with the shortest time belongs.

If the power plan setting specified with the shortest time is equal to or less than 1 minute, the MPU 11 sets the face detection interval time TINT to 45 seconds.

If the power plan setting specified with the shortest time TMIN is more than 1 minute and equal to or less than 20 minutes, the MPU 11 sets the face detection interval time TINT to TMIN/2 minutes.

If the power plan setting specified with the shortest time TMIN is more than 20 minutes, the MPU 11 sets the face detection interval time TINT to 10 minutes.

Therefore, in the example illustrated in FIG. 3A, because TMIN=TDIM=2 minutes, the face detection interval time TINT is set as: TINT=2/2=1 minute.

Similarly, in the example illustrated in FIG. 3B, because TMIN=TDIM=25 minutes, the face detection interval time TINT is set as: TINT=10 minutes.

The MPU 11 sets the face detection interval time TINT to a face detection interval timer (an internal timer corresponding to an elapsed time timer), and causes the timer to start counting.

The MPU 11 then determines if any user operation is performed via the operation device 19 (S13).

If it is determined by the determination at S13 that no user operation is performed via the operation device 19 (No at S13), the MPU 11 determines if the face detection interval timer reaches the count (counted up) (S15).

If it is determined by the determination at S15 that the face detection interval timer has not been reached the count yet (No at S15), the process proceeds to S13 again, and the same process is performed thereafter.

If it is determined by the determination at S15 that the face detection interval timer has been reached the count (Yes at S15), the camera 18 captures an image by powering the camera 18 on only for a time required for the image capturing, acquires data thus captured, and powers off the camera 18 again (S16).

The MPU 11 then performs the face detection process, in other words, a user presence detection process (S17).

The MPU 11 then determines if a face is detected, i.e., the presence of the user, in the face detection process at S17 (S18).

If it is determined by the determination at S18 that no face is detected, i.e., the user is absent (No at S18), the MPU 11 powers off the display 17 via the internal I/O 14 (S19).

Powering off the display 17 herein means an off-state in which the display 17 is caused to cease effectively displaying an image, and includes not only the actual powering off of the display, but also turning off of the backlight, when the display 17 is a liquid crystal display using a backlight, for example. In other words, powering off includes a situation where the display control is continued but no image is effectively displayed.

The MPU 11 then proceeds to the process to S13, and the same process is repeated thereafter.

If it is determined by the determination at S18 that a face is detected, i.e., the user is present (Yes at S18), the MPU 11 resets the OS timer for causing the OS to make a transition to the energy saving mode (corresponds to a power saving transition timer) (S20). In this manner, the OS timer, which is managed by the OS, and the face detection interval timer are prevented from being managed independently and individually, and are managed centrally.

The MPU 11 then powers on the display 17 (or keeps the power on of the display 17) via the internal I/O 14 (S21).

The process then proceeds to S13 again, and the same process is repeated thereafter.

As explained above, according to the first embodiment, while the presence of a user is not detected, the display can be powered off in a time shorter than the power plan setting with the shortest TMIN that is specified in the OS timer for causing the OS to make a transition to the energy saving mode. Therefore, better power saving can be achieved.

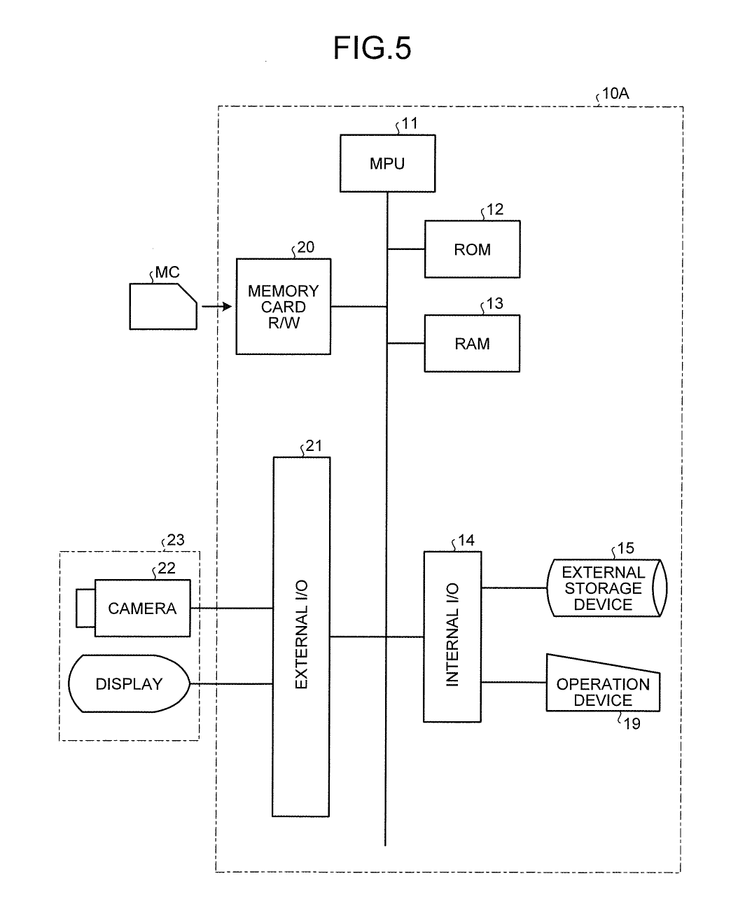

FIG. 5 is a block diagram of an outlined configuration of an information processor according to a modification of the first embodiment.

Explained in first the embodiment is an example in which the information processor 10 is a laptop PC comprising an internal camera, and the display 17 and the camera 18 are integrally housed in the display panel module 16 of the information processor 10. An information processor 10A according to the modification of the first embodiment is configured as a desktop PC comprising an external I/O module 21 for performing various interfacing operations with an external device, instead of the display panel module 16 in which the display 17 and the camera 18 are integrally housed, and to which an external display 23 is connected via the external I/O 21. A camera 22 is then integrally housed in the external display 23.

In the modification of the first embodiment having the configuration explained above as well, while the presence of the user is not detected, the display can be powered off in a time shorter than the power plan setting having the shortest TMIN that is specified in the OS timer for causing the OS to make a transition to the energy saving mode, in the same manner as in the first embodiment. Therefore, better power saving can be achieved.

Explained above is an example in which the display 17 and the camera 18 are integrally housed in the display panel module 16 of the information processor 10. A second embodiment is an example in which an external display is connected to a laptop PC having the same structure as the information processor 10 according to the first embodiment, and the external display is used as a main display.

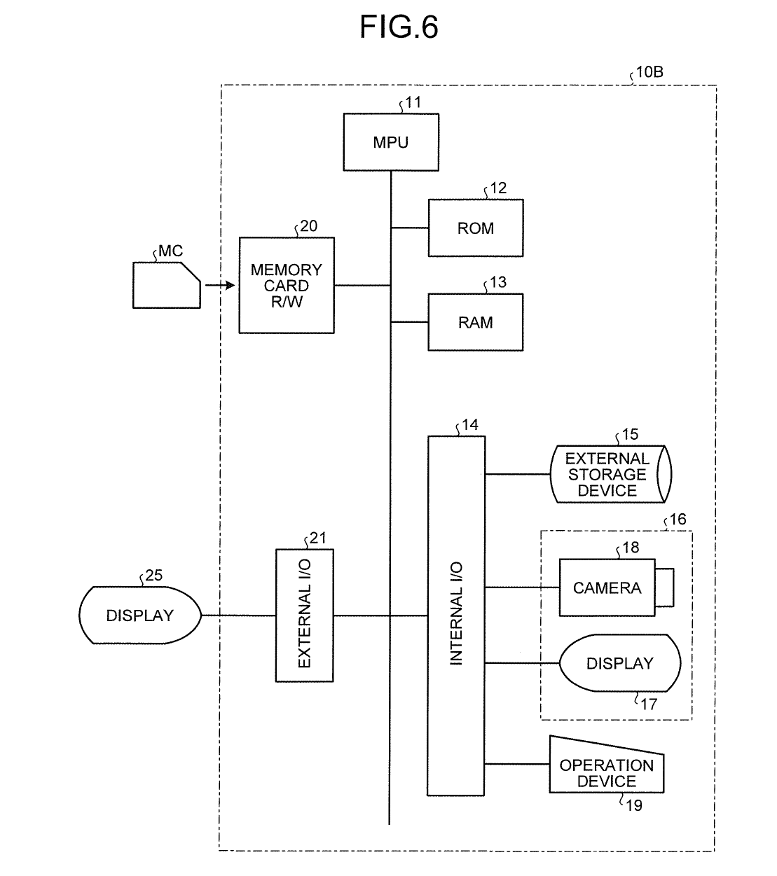

FIG. 6 is a block diagram of an outlined configuration of an information processor in the second embodiment. In FIG. 6, the elements that are the same as those in FIG. 1 or FIG. 5 are assigned with the same reference numerals.

An information processor 10B according to the second embodiment comprises an MPU 11 that controls the overall information processor 10B, a ROM 12 being a non-volatile memory storing therein control programs and the like executed by the MPU 11, a RAM 13 that is used as a working area of the MPU 11 and temporarily stores therein various types of data, an internal I/O (I/O module) 14 performing various interfacing operations, and an external storage device 15 configured as a hard disk drive, an SSD, or the like connected via the internal I/O 14 and storing therein various types of data.

The information processor 10B also comprises the display 17 configured as a liquid crystal display, an electroluminescent (EL) display, or the like housed in the display panel module 16, the camera 18 being a camera device including CCD imaging elements or CMOS imaging elements, the operation device 19 configured as a keyboard, a touch panel, a mouse, and the like and allowing a user to perform various operations, and the memory card reader-writer (R/W) 20 into which a memory card MC that is a recording medium is inserted and that reads and writes various types of data.

The information processor 10B also comprises the external I/O (I/O module) 21 performing various interfacing operations with an external device, and an external display 25 that is connected via the external I/O (I/O module) 21.

A difference for a user in using the information processor 10B according to the second embodiment from using the information processor 10 according to the first embodiment is that, because the user uses the external display as a main display, the user makes operations without looking directly at the camera 18.

Therefore, in this example, if the face detection is performed in the same manner as in the first embodiment assuming that the user is making operations facing directly at the direction captured by the camera 18, the presence of the user might not be recognized based on the face recognition, because the camera 18 captures a side view of the user's face. If the user is detected absent despite the user's presence, usability is reduced.

To address this issue, in such a case, the external display 25 is positioned where the external display 25 is to be used, and image data to be used for face detection is captured by the camera 18 in advance. Objects are then recognized from the image data thus captured, and are used as dictionary data for determining similarity in face detection.

In this manner, even when the external display 25 is used, the presence of a user can be detected reliably, and power can be saved reliably, without sacrificing the usability for users.

Explained above is an example in which the electronic device is an information processor (computer); however, the embodiments may also be applied to any electronic device using a display, such as a television and a video recorder.

Explained above is an example in which the face detection interval timer is set only once at the initial setting. However, it is also possible to set the face detection interval time to a time shorter than the face detection interval time set at S12 (corresponding to the first time) when the user's presence is no longer detected (Yes at S18) and the display is powered off (S19), until the presence of the user is detected again. Furthermore, it is also possible to keep performing the face detection successively, without setting the face detection interval time.

Furthermore, nothing is mentioned above about when the power plan setting is updated. When the power plan setting is updated, the time set to the face detection interval timer is also updated. In this manner, the face detection interval timer is always set shorter than the shortest time to which the power plan setting is specified, and energy saving can be achieved reliably.

Explained above is an example in which a user's presence is detected by detecting a face using an image recognition technology (object recognition technology); however, an object recognized is not limited to a face. It is also possible to detect the user's presence by extracting characteristics from an image in which at least a part of the body of a user, e.g., an upper torso, is captured, and applying an image recognition process such as pattern matching, statistical pattern recognition, structural pattern recognition, or the like, to the characteristics.

Furthermore, means for detecting the user's presence is not limited to the image recognition process, and the user's presence may be detected by using a near field communication, such as via radio frequency identification (RFID) where a unique identification (ID) is assigned for each user, or using a proximity sensor. In such a configuration, the face detection interval time at which the camera is driven may be applied as near field communication interval time or sensor detection interval time.

The control program executed on the electronic device according to the embodiments is provided in a manner incorporated in the ROM or the like in advance.

The control program executed on the electronic device according to the embodiments may also be provided in a manner recorded in a computer-readable recording medium, such as a compact disk read-only memory (CD-ROM), a flexible disk (FD), a compact disk recordable (CD-R), a digital versatile disk (DVD), and a memory card, as a file in an installable or executable format.

Furthermore, the control program executed on the electronic device according to the embodiments may be stored in a computer connected to a network such as the Internet, and may be made available for downloads over the network. Furthermore, the control program executed on the electronic device according to the embodiment may be provided or distributed over a network such as the Internet.

The control program executed on the electronic device according to the embodiments has a modular structure including each module explained above (a display controller, a user presence determination module, a reference elapsed time storage module, an interval time setting module, and a power controller). As actual hardware, for example, by causing a central processing unit (CPU) (processor) to read the computer program from the ROM and to execute the computer program, each of the display controller, the seated user determining module, the reference elapsed time storage module, the interval time setting module, and the power controller is loaded onto the main memory, and is generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display controller configured to cause a display to display various types of information;
a user presence determination module configured to determine whether a user is present at a first time interval;
a reference elapsed time storage module configured to store therein a second time for changing an operation mode to a power saving mode based on a time elapsed from when a user operation is ceased to be detected;
an interval time setting module configured to set the first time interval shorter than the second time based on the second time stored in the reference elapsed time storage module; and
a display controller configured to turn off the display if the user presence determination module determines that the user is absent.

2. The electronic device of claim 1, wherein
the reference elapsed time storage module is configured to store therein a plurality of second times corresponding to a plurality of power saving modes, respectively, and
the interval time setting module is configured to set the first time interval shorter than a shortest one of the second times.

3. The electronic device of claim 1, wherein the user presence determination module comprises an image recognizing module configured to receive captured image data and to recognize the user included in an image corresponding to the image data.

4. The electronic device of claim 3, wherein a camera for capturing an image and outputting the image data is configured to be embedded in the electronic device or to be externally connected to the electronic device.

5. The electronic device of claim 3, wherein the image recognizing module is configured to recognize the user's face if the user is to be recognized.

6. The electronic device of claim 1, wherein the display is configured to be embedded in the electronic device or to be connected to the electronic device as an externally connected device.

7. The electronic device of claim 3, wherein
a camera capturing an image and outputting the image data is configured to be embedded in the electronic device, and the display is configured to be capable of externally connected to the electronic device as an externally connected device, and
the image recognizing module is configured to receive image data in which a direction toward which the display is positioned is captured by the camera.

8. The electronic device of claim 1, further comprising an elapsed time timer configured to count the time elapsed, wherein
a count of the elapsed time timer is configured to be reset if the user presence determination module determines that the user is present.

9. The electronic device of claim 8, wherein the elapsed time timer is configured to be stopped if the user presence determination module determines that the user is absent.

10. The electronic device of claim 1, further comprising a power saving transition timer for changing the operation mode to a power saving mode based on the second time stored in the reference elapsed time storage module, wherein
a count of the power saving transition timer is configured to be reset if the user presence determination module determines that the user is present.

11. The electronic device of claim 1, wherein the interval time setting module is configured to update the first time interval if the second time in the reference elapsed time storage module is updated.

12. An electronic device controlling method performed in an electronic device comprising a reference elapsed time storage module configured to store therein a second time for changing an operation mode to a power saving mode based on a time elapsed from when a user operation is ceased to be detected, the electronic device causing a display to display various types of information, the electronic device controlling method comprising:
determining whether a user is present at a first time interval;
setting the first time interval shorter than the second time based on the second time stored in the reference elapsed time storage module; and
turning off the display if the determining determines that the user is absent.

13. A computer program product having a non-transitory computer readable medium including programmed instructions for controlling an electronic device comprising a reference elapsed time storage module configured to store therein a second time for changing an operation mode to a power saving mode based on a time elapsed from when a user operation is ceased to be detected, the electronic device causing a display to display various types of information, wherein the instructions, when executed by a computer, cause the computer to perform:
determining whether a user is present at a first time interval;
setting the first time interval shorter than the second time based on the second time stored in the reference elapsed time storage module; and
turning off the display if the determining determines that the user is absent.
